(19) United States
(12) Patent Application Publication
(10) Pub. No.: US 2025/0162326 A1
(43) Pub. Date: May 22, 2025

(54) PRINTING APPARATUS AND CONTROL METHOD

(71) Applicant: CANON KABUSHIKI KAISHA, Tokyo (JP)

(72) Inventors: KENTARO MURO, Tokyo (JP); JUN YASUTANI, Kanagawa (JP)

(21) Appl. No.: 18/946,754

(22) Filed: Nov. 13, 2024

(30) Foreign Application Priority Data
Nov. 16, 2023 (JP) 2023-195294

(51) Int. Cl. B41J 2/18; B41J 2/155; B41J 2/165; B41J 11/00; B41J 25/308

(52) U.S. Cl. CPC B41J 2/18; B41J 2/155; B41J 2/16511; B41J 11/003; B41J 11/0085; B41J 25/308

(57) ABSTRACT

A printing apparatus includes a moving unit configured to relatively move a printing medium and a discharging unit configured to discharge a liquid onto the printing medium; and a control unit configured to obtain information related to a speed of airflow at a discharge port surface of the discharging unit and, based on the obtained information, control an adjustment operation for adjusting a density of a solid component of the liquid. A printing mode is selectable from a plurality of types of printing modes. The information includes information identifying a type of a selected printing mode.

### BACKGROUND

### Field

The present disclosure relates to a printing apparatus and a control method.

### Description of the Related Art

When a discharge head for discharging a liquid, such as ink, continues to be in a state in which it does not discharge the liquid for a long period of time, a volatile component in the liquid evaporates from discharge ports, and the liquid becomes concentrated, thus increasing in a density of a solid component, such as a pigment. An increase in liquid density causes discharge failure. A technique for discharging a liquid from a discharge head when it is estimated that the density has increased is known (e.g., Japanese Patent Laid-Open No. 2018-8513).

When the liquid is discharged from the discharge head, the consumption of the liquid increases; it is desirable to reduce the consumption of the liquid not used for printing. For this, it would be desirable to estimate the density of the liquid more accurately.

### SUMMARY

The present disclosure provides a technique for controlling an operation for adjusting the density of a liquid by estimating the density more accurately.

According to some embodiments, a printing apparatus includes a moving unit configured to relatively move a printing medium and a discharging unit configured to discharge a liquid onto the printing medium; and a control unit configured to obtain information related to a speed of airflow at a discharge port surface of the discharging unit and, based on the obtained information, control an adjustment operation for adjusting a density of a solid component of the liquid, wherein a printing mode is selectable from a plurality of types of printing modes, and the information includes information identifying a type of a selected printing mode.

Further features of the present disclosure will become apparent from the following description of exemplary embodiments (with reference to the attached drawings).

### BRIEF DESCRIPTION OF THE DRAWINGS

FIG. 1 is a schematic diagram of a printing apparatus according to some embodiments of the present disclosure.

FIG. 2 is a plan view of a conveyance unit of the printing apparatus of FIG. 1.

FIG. 3A is an explanatory view illustrating a configuration of a discharge head.

FIG. 3B is an explanatory view illustrating a configuration of a heater board.

FIG. 4A is a cross-sectional view of the discharge head.

FIG. 4B is an explanatory view of a circulation unit.

FIGS. 5A to 5C are diagrams illustrating examples of changing of the heights of discharge heads.

FIG. 6 is an explanatory view of capping of the discharge heads.

FIG. 7 is a block diagram of a control unit of the printing apparatus of FIG. 1.

FIG. 8 is a flowchart for explaining an example of processing to be executed by the control unit.

FIG. 9A is a flowchart for explaining an example of processing to be executed by the control unit.

FIG. 9B is a diagram illustrating an example of settings for an evaporation speed.

FIG. 10 is a flowchart for explaining an example of processing to be executed by the control unit.

FIGS. 11A to 11C are diagrams illustrating examples of data used in processing.

FIGS. 12A and 12B are diagrams illustrating an example of an intermediate standby position.

FIG. 12C is a diagram illustrating an example of settings for the evaporation speed.

FIG. 13A is a diagram illustrating an example of a portion of a conveyance belt with the presence or absence of a printing medium.

FIG. 13B is a diagram illustrating another example of settings for the evaporation speed.

FIG. 13C is a diagram illustrating an example of calculation of an evaporated quantity.

FIG. 14A is a diagram illustrating another example of the configuration of the conveyance unit.

FIG. 14B is a diagram illustrating another example of settings for the evaporation speed.

FIG. 15 is a diagram illustrating another example of settings for the evaporation speed.

FIGS. 16A and 16B are diagrams illustrating an example of application in a serial printing apparatus.

FIG. 17 is a diagram illustrating another example of an ink discharge site.

### DESCRIPTION OF THE EMBODIMENTS

Hereinafter, various exemplary embodiments, features, and aspects will be described in detail with reference to the attached drawings. Note, the following embodiments are not intended to limit the scope of the claimed disclosure. Multiple features are described in the embodiments, but limitation is not made to a disclosure that uses all such features, and multiple such features may be combined as appropriate. Furthermore, in the attached drawings, the same reference numerals are given to the same or similar configurations, and redundant description thereof is omitted.

### First Embodiment

### <Configuration of Printing Apparatus>

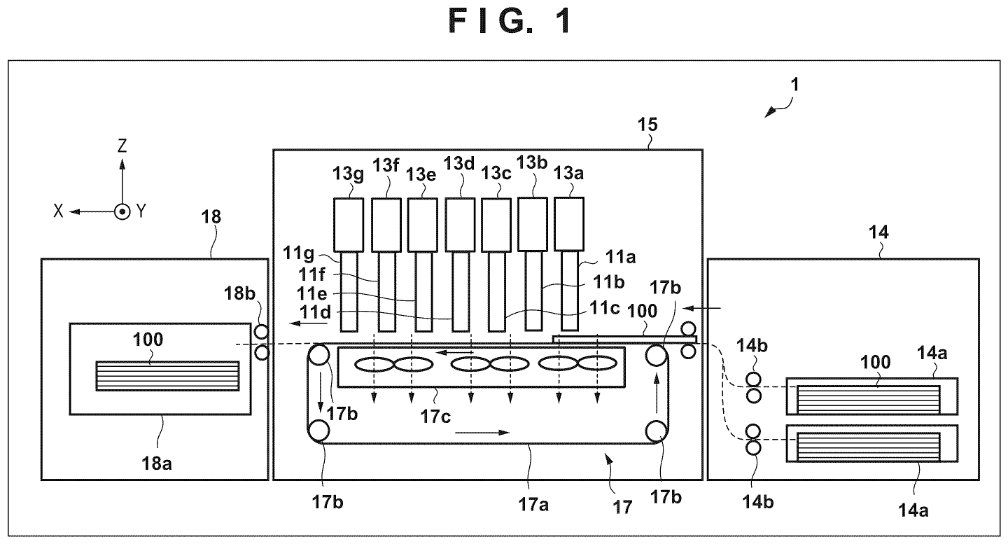

FIG. 1 is a schematic diagram of a printing apparatus 1 according to one embodiment of the present disclosure. The printing apparatus 1 is an apparatus that discharges liquid ink onto a printing medium 100 to print an image. In the figure, arrows X, Y, and Z indicate directions that intersect each other, and an X direction and a Y directions are horizontal directions perpendicular to each other. A Z direction is a vertical direction. In the case of the present embodiment, the X direction, the Y direction, and the Z direction indicate a total length direction, a depth direction, and a height direction of the printing apparatus 1, respectively.

“Printing” includes not only cases of forming meaningful information, such as characters and shapes, but also, broadly, cases of forming an image, a design, a pattern, or the like, regardless of whether they are meaningful or meaningless, on a printing medium or cases of processing a medium, and it does not matter whether “printing” is manifested as being visually perceptible by humans. In addition, although sheet-like paper is assumed as a “printing medium” in the present embodiment, it may be a cloth, a plastic film, or the like.

The printing apparatus 1 includes a feeding apparatus 14, an image forming apparatus 15, and a collection apparatus 18. The feeding apparatus 14 is an apparatus that feeds a printing medium 100 to the image forming apparatus 15. The feeding apparatus 14 includes a stacking unit 14a in which a plurality of printing media 100 on which printing has not been performed are stacked and a conveyance mechanism 14b. In the present embodiment, a plurality of stacking units 14a is provided, and the conveyance mechanism 14b is provided for each stacking unit 14a. The conveyance mechanism 14b includes a pair of rollers that pinch and convey the printing medium 100.

The collection apparatus 18 is an apparatus that collects a printed printing medium 100 discharged from the image forming apparatus 15. The collection apparatus 18 includes a stacking unit 18a in which a plurality of printing media 100 that are printed products are stacked and a conveyance mechanism 18b. The conveyance mechanism 18b includes a pair of rollers that pinch and convey the printing medium 100.

The image forming apparatus 15 includes a conveyance unit 17 which conveys a printing medium 100 in the X direction, a plurality of discharge heads 11a to 11g which discharge a liquid onto the printing medium 100, and elevating units 13a to 13g which raise and lower the discharge heads 11a to 11g. When the discharge heads 11a to 11g are collectively referred to or individual discharge heads 11a to 11g are not distinguished, they are simply referred to as the discharge heads 11. Similarly, when the elevating units 13a to 13g are collectively referred to or individual elevating units 13a to 13g are not distinguished, they are simply referred to as the elevating units 13.

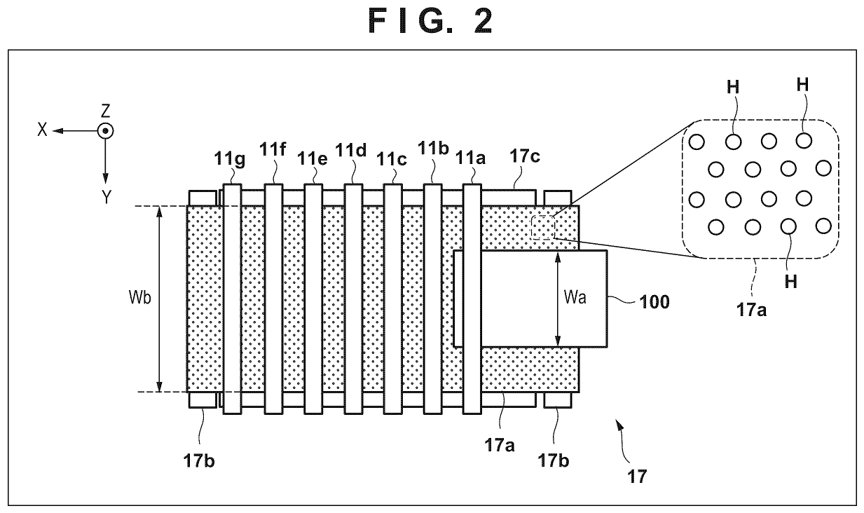

FIG. 2 is referenced in addition to FIG. 1. FIG. 2 is a plan view of the conveyance unit 17. The conveyance unit 17 is an example of a moving mechanism that moves the discharge heads 11 and a printing medium 100 in a relative manner and, here, moves the printing medium 100 relative to the stationary discharge heads 11 to move the two in a relative manner. The conveyance unit 17 includes an endless conveyance belt 17a, a plurality of rollers 17b for driving the conveyance belt 17a, and a suction apparatus 17c. The plurality of rollers 17b are rotated about an axis in the Y direction by a driving source (not illustrated) (e.g., a motor). The conveyance belt 17a is driven in a circulative manner in a counterclockwise direction as viewed in FIG. 1 by rotation of the plurality of rollers 17b.

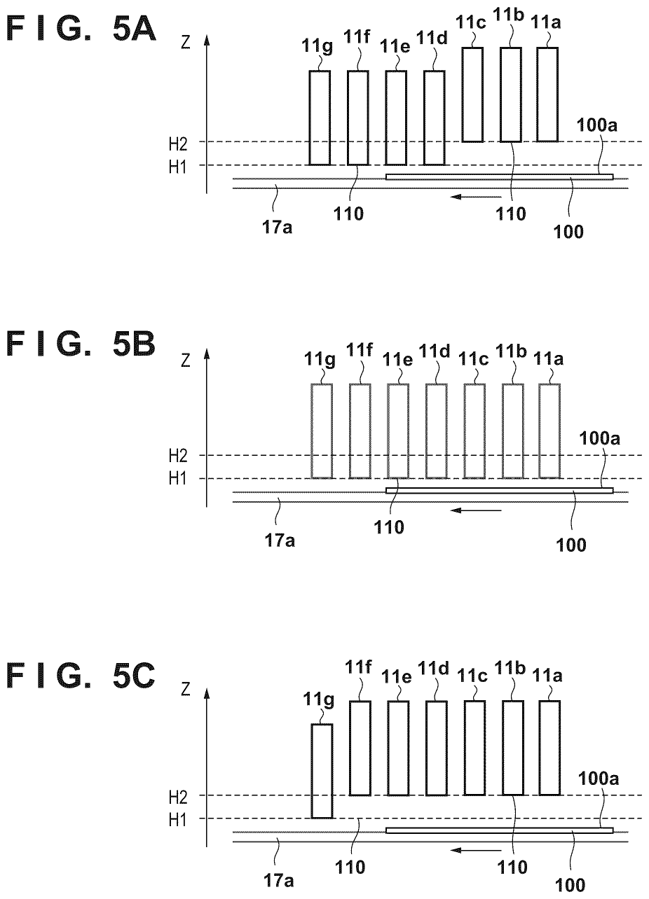

The materials of the conveyance belt 17a include resin, metal, and the like. The conveyance belt 17a is a conveyance medium for a printing medium 100 that travels in the X direction with the printing medium 100 mounted on a portion of a traveling section thereof (referred to as a conveyance section or a printing section). The conveyance belt 17a faces the bottom surfaces (discharge port surfaces 110 illustrated in FIG. 5A and the like to be described later) of the discharge heads 11 in the conveyance section.

A large number of holes H are formed in the conveyance belt 17a at predetermined pitches. The suction apparatus 17c includes, for example, an electric fan and, in the conveyance section, is positioned below the conveyance belt 17a and generates an airflow from upstream to downstream in the Z direction. By the function of the suction apparatus 17c, the air is suctioned from the large number of holes H of the conveyance belt 17a in the conveyance section. With this, the printing medium 100 is conveyed while being suctioned onto the conveyance belt 17a in the conveyance section, and the conveyance behavior of the printing medium 100 can be stabilized. The pressure of air to be suctioned can be, for example, −500 Pa (pascal). The conveyance speed can be, for example, 0.7 m/s (meter per second).

In the present embodiment, suction conveyance in which air suction is utilized is assumed as the form of conveyance of the printing medium 100, but suction conveyance in which static electricity suction is utilized may be assumed. Further, a unit having functions, such as drying or cooling of the printing medium 100, may be added to the conveyance unit 17.

A discharge head 11 is a printing head that discharges ink onto the printing medium 100 to print an image. The discharge head 11 is a full-line head that is extended in a width direction (Y direction) of the printing medium 100, and liquid discharge ports are arranged across a range covering the width of a maximum size of the printing medium 100 that can be used. FIG. 2 illustrates a width Wa of an intermediate size of the printing medium 100 as an example. An effective length (e.g., 368 mm (millimeter)) of an array of discharge ports of the discharge head 11 fits within a width Wb (e.g., 380 mm) of the conveyance belt 17a.

The discharge heads 11a to 11g are arranged from an upstream side to a downstream side of a conveyance direction of the printing medium 100. The discharge heads 11a to 11g discharge different types of inks. For example, the discharge heads 11a to 11c discharge three types of inks, which are orange ink, green ink, and violet ink, in order. These three types of inks are sometimes referred to as spot color inks. Further, the discharge heads 11d to 11g discharge four types of inks, which are black ink, yellow ink, magenta ink, and cyan ink, in order. These four types of inks are sometimes referred to as basic color inks. The types and number of inks and the order (order in which the discharge heads 11a to 11g are arranged) of discharge in the conveyance direction of the printing medium 100 are not limited thereto.

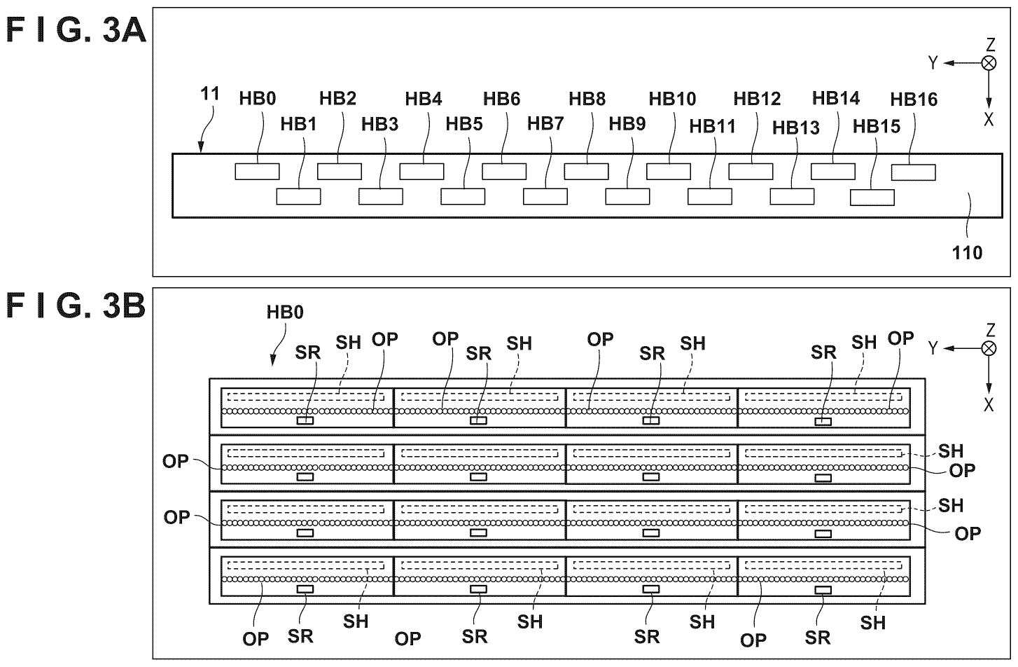

The configuration of a discharge head 11 will be described with reference to FIGS. 3A and 3B. FIG. 3A is an explanatory view illustrating the configuration of the discharge head 11, and FIG. 3B is an explanatory view of a heater board. As illustrated in FIG. 3A, 17 heater boards (printing element substrates) HB0 to HB16 are provided on the discharge head 11 as an example. FIG. 3B illustrates an example of a configuration of the heater board HB0, and other heater boards HB1 to HB16 have a similar configuration.

Arrays of discharge ports in which a plurality of discharge ports OP are arranged in the Y direction are formed on the heater board HB0. A plurality of arrays (four arrays in the example of the figure) of discharge ports are formed spaced apart in the X direction. Further, temperature sensors SR and sub heaters SH, which are heating elements, are arranged on the heater board HB0. When a voltage is applied to a sub heater SH, the sub heater SH generates heat to heat a substrate of the heater board HB0, and the heated substrate heats ink near the substrate. By adjusting the temperature of ink using the sub heaters SH in advance, it is possible to efficiently discharge the ink when discharging the ink. The heater board HB0 is divided into 4×4=16 sections, and one sub heater SH is provided in each section. With this, it is possible to heat the heater board HB0 in units of sections.

A temperature sensor SR is a sensor for detecting the temperature of the heater board HB0. In the present embodiment, the temperature of ink can be set to a desired temperature by controlling application of a driving pulse to a sub heater SH based on the temperatures detected by the temperature sensor SR during printing and before printing.

As illustrated in FIG. 3A, the heater boards HB0 to HB16 each are arranged in a staggered manner such that the ends of arrays of discharge ports of neighboring heater boards overlap each other in the X direction. The bottom surface of each discharge head 11 forms a discharge port surface 110 on which such arrays of discharge ports are formed. The discharge head 11 need not be constituted by the plurality of heater boards HB0 to HB16 and may be constituted by a heater board having one array of long discharge ports in the Y direction.

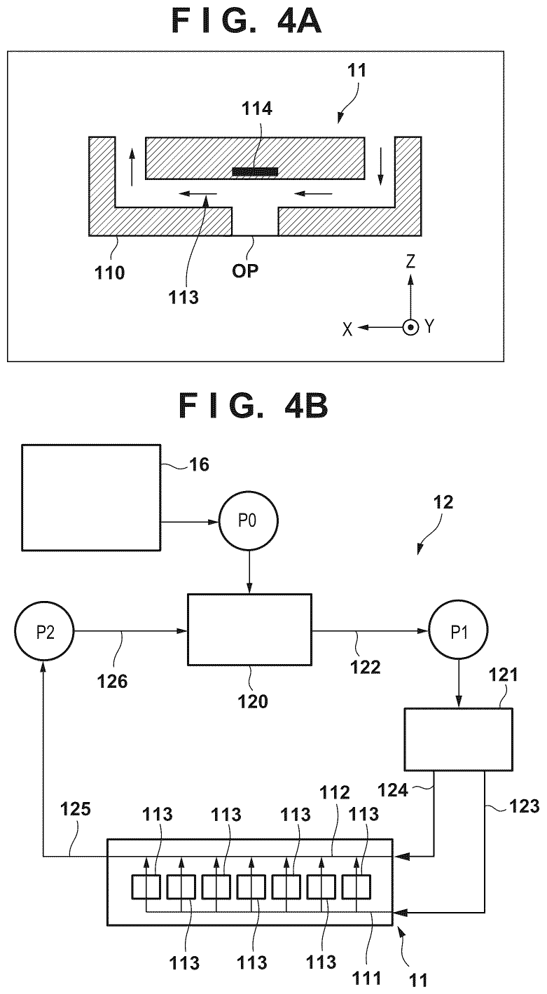

FIG. 4A is an X-Z cross-sectional view of the periphery of one discharge port OP. The discharge port OP is connected to an individual flow path 113 for that respective discharge port OP, and a printing element 114 for that respective discharge port OP is provided in the individual flow path 113. The printing element 114 is, for example, an electric-thermal conversion element, and generates thermal energy by a driving pulse being applied thereto. By the generated thermal energy causing ink to bubble, the ink is discharged from a corresponding discharge port OP. In addition to the electric-thermal conversion element, a piezoelectric element, an electrostatic element, or an MEMS element may be used as the printing element 114.

In the individual flow path 113, ink flows in a direction indicated by an arrow in FIG. 4A. In the present embodiment, ink is supplied in a circulative manner to the discharge head 11. FIG. 4B is an explanatory view of a circulation unit 12, which circulates ink.

The printing apparatus 1 includes a main tank 16, a sub tank 120, and a circulation unit 12 for each discharge head 11. The main tank 16 and the sub tank 120 are liquid containers for storing ink to be discharged by a corresponding discharge head 11. For example, the main tank 16 and the sub tank 120 corresponding to the discharge head 11a contain orange ink. When a pump P0 is driven, ink is supplied from the main tank 16 to the sub tank 120. When a predetermined amount of ink is supplied from the main tank 16 to the sub tank 120, the supply of ink is stopped, and when the remaining amount of ink in the sub tank 120 decreases, for example, ink is supplied again.

The circulation unit 12 includes pumps P1 and P2 and a pressure adjuster 121. The pump P1 pumps ink from the sub tank 120 through a tube 122 to the pressure adjuster 121. The pressure adjuster 121 adds a pressure difference to the supplied ink and delivers the ink to the discharge head 11. The ink on a relatively high-pressure side is delivered through a tube 123, and the ink on a low-pressure side is delivered through a tube 124.

The discharge head 11 includes common flow paths 111 and 112. The common flow path 111 is connected to the tube 123, and ink on the high-pressure side is supplied. One end of the common flow path 112 is connected to the tube 124, and ink on the low-pressure side is supplied. Each individual flow path 113 is connected between the common flow path 111 and the common flow path 112. Ink flows from the common flow path 111 through the individual flow paths 113 to the common flow path 112.

The other end of the common flow path 112 is connected to a tube 125. The pump P2 pumps ink from the common flow path 112 through tubes 125 and 126 to the sub tank 120. Ink is thus circulated between the sub tank 120 and the discharge head 11.

The elevating units 13 will be described with reference to FIG. 1 and FIGS. 5A to 5C. FIGS. 5A to 5C are diagrams illustrating examples of changing of the heights of the discharge heads 11.

An elevating unit 13 is a mechanism that changes a height from the surface of a printing medium 100 to the discharge port surface 110 of a discharge head 11 in the conveyance section of the conveyance belt 17a. In the present embodiment, the height from the surface of the printing medium 100 to the discharge port surface 110 of the discharge head 11 is changed by raising and lowering the discharge head 11; however, the height may be changed by raising and lowering the conveyance unit 17.

The elevating unit 13 is provided for each discharge head 11 and can change the position of the discharge head 11 in the Z direction for a respective discharge head. For example, the elevating unit 13a raises and lowers the discharge head 11a to change a position thereof in the Z direction. Although each discharge head 11 can be individually raised and lowered in the present embodiment, a plurality of discharge heads 11 may be raised and lowered by one elevating unit 13. In this case, the plurality of discharge heads 11 which are raised and lowered by one elevating unit 13 will have their position in the Z direction changed in a common manner. The elevating unit 13 includes, for example, a driving source, such as a motor, and an actuating mechanism that moves the discharge head 11 using a driving force of the driving source. The actuating mechanism is, for example, a ball screw mechanism, a belt transmission mechanism, a link mechanism, or the like.

At the time of a printing operation, each discharge head 11 is arranged at a position at a height H1 or a height H2 relative to a printing medium 100. The height H1 is a height at the time of printing for when discharging ink, and the discharge head 11 to be used for printing an image is positioned at the height H1 (referred to as a printing position). The discharge port surface 110 and the surface of the printing medium 100 will have a small gap (about a few millimeters) therebetween. The height H2 is a height at the time of non-printing (time of standby), and the discharge head 11 not used for printing an image is positioned at the height H2 (e.g., several centimeters) (referred to as a standby position). The relationship is H2>H1.

In the present embodiment, a user can select a printing mode from a plurality types of printing modes. Three types of printing modes, which are a first mode in which only the basic colors are used, a second mode in which all colors including spot colors are used, and a third mode in which only black ink is used, are provided.

FIG. 5A illustrates an arrangement of the discharge heads 11 in a printing operation for when the first mode is selected. The discharge heads 11d to 11g, which discharge basic color inks, are located at the printing position, and the discharge heads 11a to 11c, which discharge spot color inks, are located at the standby position. FIG. 5B illustrates an arrangement of the discharge heads 11 in a printing operation for when the second mode is selected. All discharge heads 11a to 11g are at the printing position. FIG. 5C illustrates an arrangement of the discharge heads 11 in a printing operation for when the third mode is selected. Only the discharge head 11g, which discharges black ink, is at the printing position.

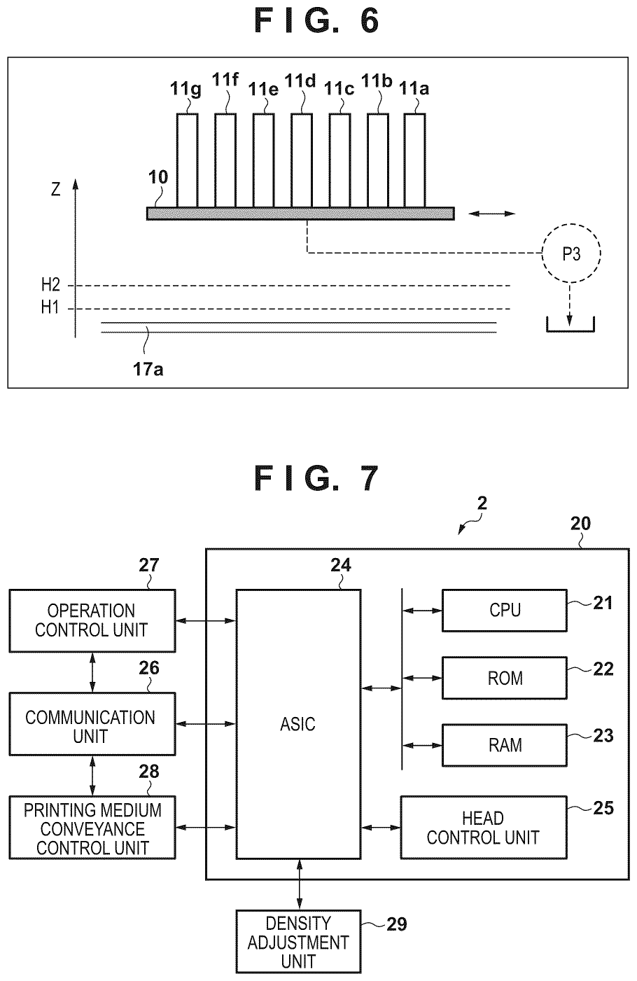

While waiting for the execution of a print job, the discharge heads 11 may be moved to a retracted position and capped. FIG. 6 illustrates an example thereof. The discharge port surface 110 of each discharge head 11 is capped by a cap member 10. During capping, each discharge head 11 is moved to the retracted position by the elevating unit 13. The retracted position is a position that is higher than the height H2. The standby position may be the same position as the retracted position.

The cap member 10 is moved by a moving mechanism (not illustrated) between a capped position at which the discharge port surfaces 113 are covered as illustrated in FIG. 6 and the retracted position at which the discharge port surfaces 113 are not covered. The capping prevents a liquid component of ink from evaporating from the discharge ports OP during execution standby. Upon a print instruction being received, the cap member 10 is moved from the capped position to the retracted position to release a capped state. Then, the discharge heads 11 are lowered to the printing position or the standby position by being driven by the elevating units 13. Then, the conveyance of the printing medium 100 by the conveyance unit 17 is started. An image is printed on the printing medium 100 with a timing at which the printing medium 100 passes under the discharge heads 11 and a timing at which ink is discharged being synchronized. When the printing of the image is completed, the discharge heads 11 are raised to the retracted position again and are capped.

The discharge heads 11 may be retracted, and an operation for recovering discharge performance may be performed together with capping. As an example, a suction recovery operation in which ink is suctioned from the discharge ports OP of the discharge heads 11 may be performed. As an example, FIG. 6 illustrates an example in which ink is suctioned from the discharge ports OP of the discharge heads 11 through the cap member 10 and a tube by the pump P3 and is discharged to a waste liquid tank. In addition to such a suction recovery operation, a preliminary discharge operation can be given as an operation for recovering discharge performance. In the preliminary discharge operation, ink is discharged from the discharge ports OP of the discharge heads 11. The discharge destination is, for example, the cap member 10.

### <Control Unit>

FIG. 7 is a block diagram of a control unit 2 of the printing apparatus 1. The control unit 2 includes a printer control unit 20, which controls a printing process. The printer control unit 20 includes a CPU 21 for controlling the entire printing apparatus 1, a ROM 22 for storing control programs and various types of data to be executed by the CPU 21, and a RAM 23. An Application Specific Integrated Circuit (ASIC) 24 incorporates a network controller, a serial IF controller, a controller for head data generation, a motor controller, and the like. A head control unit 25 generates final discharge data for causing the discharge heads 11 to perform discharge, generates a driving voltage, and controls raising and lowering of the discharge heads 11, for example.

The control unit 2 also includes a communication unit 26 for receiving a print job including print data from an external print server or an external PC, an operation control unit 27 for controlling an operation panel or the like that receives input of the user, and a printing medium conveyance control unit 28 for controlling conveyance of the printing medium 100. The control unit 2 also includes a density control unit 29 for controlling an adjustment operation for adjusting the density of a solid component in ink circulated by the circulation units 12. Each control unit includes at least one processor and at least one storage device that stores a program to be executed by the processor. The storage device is, for example, a semiconductor memory.

### <Adjustment of Density of Circulating Ink>

The inks in the discharge head 11 increases in density of the solid component in the ink due to a volatile component in the ink evaporating from the discharge ports OP. The solid component is, for example, a coloring material (pigment) or a resin. An increase in density of the solid component causes discharge failure. Therefore, an adjustment operation for adjusting the density of circulating ink is performed for each type of ink. The adjustment operation of the present embodiment is an operation of discharging ink in the discharge head 11. The density of the solid component in the circulating ink is uneven, and the density is often high for ink in the discharge head 11. By discharging ink in the discharge head 11, it is possible to reduce the density of the solid component in the circulating inks. The operation of discharging ink in the discharge head 11 may be an operation of discharging ink from the discharge head 11 or an operation of suctioning ink through the cap member 10 by the pump P3 illustrated in FIG. 6. In addition to the operation of discharging ink in the discharge head 11, the adjustment operation may include an operation of driving the pump P0 to replenish ink from the main tank 16 to the sub tank 120. The circulating ink in which the density of the solid component has increased can be diluted with the ink in the main tank 16.

When ink in the discharge head 11 is discharged by the adjustment operation, the amount of waste ink increases. It is desired to reduce unnecessary ink consumption as much as possible. To do so, it is necessary to improve the accuracy of estimation of the density of the solid component. Various elements affect the evaporation speed of the volatile component, but in an apparatus in which the discharge heads 11 and the printing medium 100 are moved in a relative manner as in the present embodiment, there is an airflow at the discharge port surfaces 113. It is considered that the speed of airflow also affects the evaporation speed; the faster the flow speed, the faster the evaporation speed, and the slower the flow speed, the slower the evaporation speed. In addition, in a form in which the printing medium 100 is suctioned and conveyed by the suction apparatus 17c as in the present embodiment, the effect of the airflow thereof is strong. Therefore, in the present embodiment, the adjustment operation is performed, taking into account the flow speed at the discharge port surfaces 113. With this, it is possible to more accurately estimate the density of ink and to control the operation for adjusting the density.

An example of processing of the control unit 2 related to the operation for adjusting the density of the solid component will be described. In the present embodiment, the density of the solid component is estimated, and the adjustment operation is performed based on a result of that estimation. These processes can be performed at a predetermined timing based on the elapse of time, the amount of execution of print jobs, the amount of ink discharge, and the like. In the following example, these processes are performed for each execution of a print job.

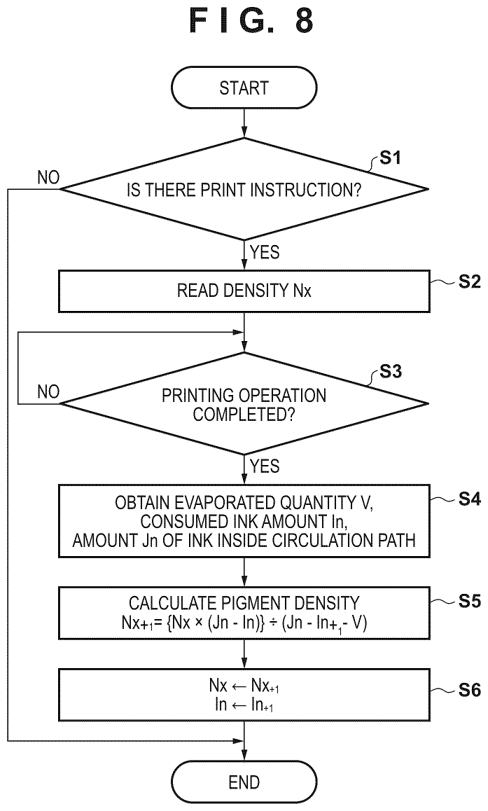

FIG. 8 is a flowchart for explaining an example of processing for estimating the density of the solid component and is executed by the density adjustment unit 29. The density of solid components is estimated for each type of ink (i.e., for each discharge head); here, a pigment is assumed as the solid component.

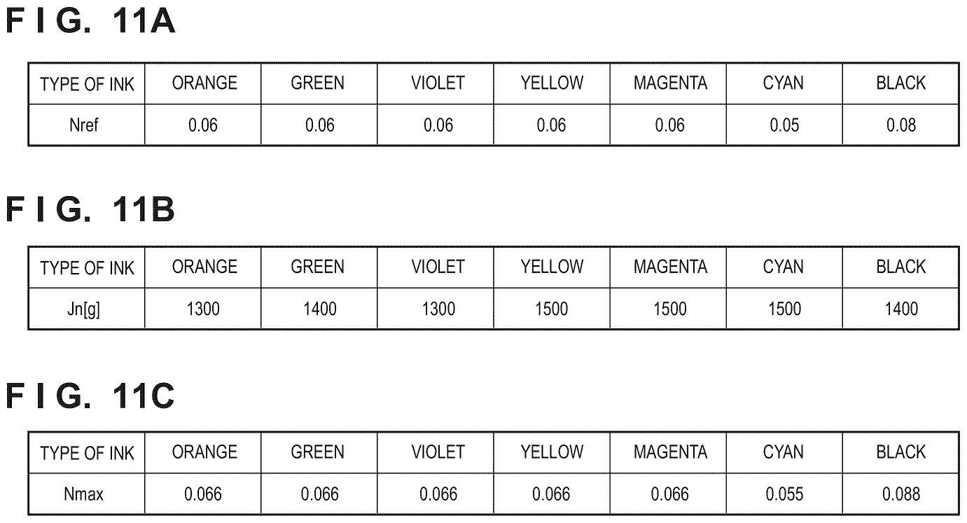

In step S1, it is determined whether there is an instruction (print instruction) to execute a print job. If there is no print instruction, the processing ends. If there is a print instruction, the processing proceeds to step S2. In step S2, a current density estimation value (previous estimation result value) Nₓ is read. The density estimation value Nₓ is stored in the storage device of the density adjustment unit 29, for example, and is updated based on an estimation result of the processing of FIG. 8. FIG. 11A is an example of settings for initial values N_{ref} for the density estimation values Nₓ. An initial value N_{ref} is the density of a pigment in fresh ink and is stored in, for example, the storage device of the density adjustment unit 29.

In step S3, it is determined whether a printing operation has been completed. When it is determined that the printing operation has been completed, the processing proceeds to step S4. In step S4, an evaporated quantity V, a consumed ink amount (cumulative value) Iₙ, and a circulating ink amount Jₙ are obtained. The circulating ink amount Jₙ is an initial value of the amount of ink in a circulation path and is set in advance based on the specifications of the circulation path. FIG. 11B illustrates an example thereof.

The consumed ink amount Iₙ is a cumulative value of the amount of ink discharged in printing operations thus far and is mainly affected by the contents of the printing operation in the respective print jobs. The amount of ink discharged in a printing operation is calculated from, for example, a count value of the number of pixels in a printed image corresponding to that type of ink. For example, it can be obtained by multiplying the count value by the amount (e.g., 2.0 [ng] (nanogram)) discharged in one discharge. By adding the amount I_{c} of ink consumed in the current printing operation, Iₙ₊₁ is calculated as Iₙ₊₁=Iₙ+I_{c}.

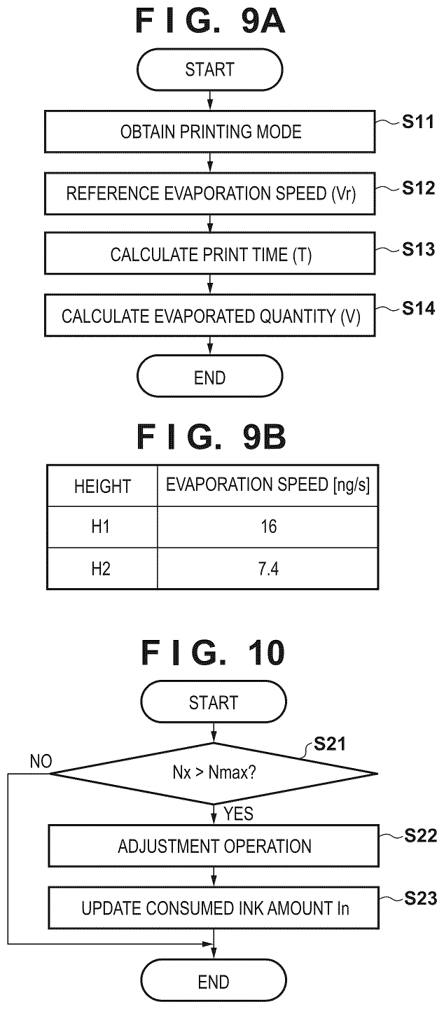

An evaporation speed of ink at the discharge ports OP is set, and the evaporated quantity V is estimated from the set evaporation speed. FIG. 9A is a flowchart for explaining an example of that calculation. In step S11, information of a printing mode selected in the current print job among the first mode to third mode of printing is obtained. The selection information of a printing mode, for example, is included in the print job or is inputted by the user in the operation panel and managed by the printer control unit 20.

In step S12, an evaporation speed Vr is referenced and set based on the information of the printing mode obtained in step S11. The evaporation speed Vr is set according to the height of the discharge head 11. FIG. 9B illustrates an example thereof. When the discharge head 11 is at the printing position (height H1) during the printing operation, the evaporation speed of ink from the discharge ports OP of the discharge head 11 is set to 16 ng/s. When the discharge head 11 is at the standby position (height H2), the evaporation speed of ink from the discharge ports OP of the discharge head 11 is set to 7.4 ng/s. When the height of the discharge head 11 is lower, that is, when the distance between the printing medium 100 and the discharge ports OP is smaller, the evaporation speed has a larger value. This is because the airflow generated by the conveyance of the printing medium 100 becomes stronger due to the distance being shorter. This value has been measured in advance by experimentation and the like, and the information of FIG. 9B is stored in the storage device of the density adjustment unit 29, for example.

As described above, in the present embodiment, the positions of the discharge heads 11 are determined according to the selection of the first mode to the third mode of printing. Therefore, an evaporation speed can be set according to the information on the printing mode obtained in step S11 and the type of ink to be processed. That is, the selection information of the first mode to the third mode of printing is an example of information identifying the type of the selected printing mode and is an example of information related to the speed of airflow at the discharge port surfaces 113. Further, the selection information of the first mode to the third mode of printing is also information identifying the heights H1 to H3 of the discharge heads 11.

For example, when the first mode is selected, the discharge heads 11d to 11g, which discharge basic color inks, are located at the printing position, and the discharge heads 11a to 11c, which discharge spot color inks, are located at the standby position. If the type of ink to be processed is black ink, the evaporation speed will be set to 16 ng/s because the corresponding discharge head 11g is positioned at the printing position. Meanwhile, if the type of ink to be processed is orange ink, the evaporation speed will be set to 7.4 ng/s because the corresponding discharge head 11a is positioned at the standby position.

Returning to FIG. 9A, in step S13, a print time T is calculated. The print time T is a time from when the discharge head 11 is lowered from the retracted position (capped position) to the position at the height H1 or H2 upon a print instruction being received to when the printing operation ends and the discharge head 11 is raised to the retracted position again. This print time T can be calculated by measuring.

In step S14, the evaporated quantity V is calculated. The evaporated quantity V is calculated by:

$$V = V r \times T \times N$$

Here, N is the number of discharge ports OP. For example, if there are 2048 (512×4 arrays) discharge ports OP per heater board among the heater boards HB0 to 16, the total number of discharge ports OP per discharge head among the discharge heads 11 will be 34816. The evaporated quantity is estimated as described above.

Returning to FIG. 8, in step S5, an updated value Nₓ₊₁ of pigment density is calculated based on the values obtained in step S4. This value is calculated by:

$${N}_{x + 1} = \{ {N}_{x} \times ( {J}_{n} - {I}_{n} ) \} / ( {J}_{n} - {I}_{n + 1} - V )$$

In step S6, the density estimation value Nₓ and the consumed ink amount Iₙ are updated with the values Nₓ₊₁ and Iₙ₊₁. With the above, the processing ends. By thus updating the density estimation value Nₓ, it is possible to manage the pigment density of ink in the circulation path.

FIG. 10 is a flowchart for explaining an example of processing related to the execution of the adjustment operation and is concentration determination processing to be executed by the density adjustment unit 29 following the processing of FIG. 8. In step S21, it is determined whether the density estimation value Nₓ does not exceed a predetermined upper limit value Nₘₐₓ (predetermined density). FIG. 11C illustrates an example of the upper limit value Nₘₐₓ. The upper limit value Nₘₐₓ is set for each type of ink and is stored in the storage device of the density adjustment unit 29, for example.

Returning to FIG. 10, if the density estimation value Nₓ does not exceed the upper limit value Nₘₐₓ, the processing ends, and if the density estimation value Nₓ exceeds the upper limit value Nₘₐₓ, the processing proceeds to step S22. In step S22, the adjustment operation is executed. As described above, the adjustment operation includes the operation of discharging ink from the discharge head 11. At that time, the greater the density estimation value Nₓ, the greater the discharge amount of ink may be. The discharge amount may be increased by increasing the discharge amount in one discharge or by increasing the number of discharges. In step S23, the discharge amount of ink discharged in step S22 is added to the consumed ink amount Iₙ. With the above, the processing ends.

As described above, in the present embodiment, since the evaporation speed of ink from the discharge ports OP is set taking into account the effect of airflow at the discharge port surface 13, the accuracy of estimation of the density of the solid component can be improved as compared with processing in which the evaporation speed is uniformly set. As a result, it is possible to prevent ink from unnecessarily being discharged in the adjustment operation and reduce the consumption amount of ink.

### Second Embodiment

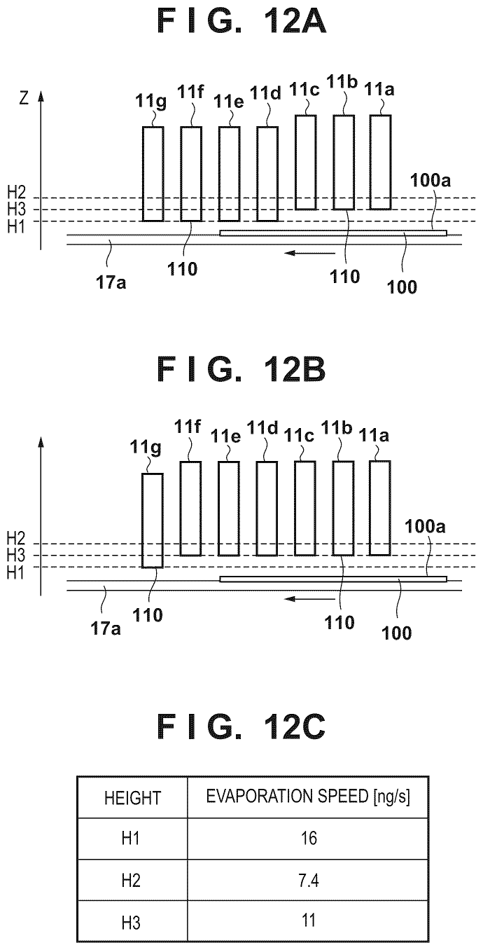

In the first embodiment, two types which are the printing position (height H1) and the standby position (height H2) have been exemplified as positions of the discharge head 11 relative to the printing medium 100 during the printing operation, but there may be three or more types. FIGS. 12A and 12B illustrate an example of the three types. In this example, an intermediate standby position (height H3) is set as a position of the discharge head 11 relative to the printing medium 100 during the printing operation, and the relationship is height H1<height H3<height H2. The travel time to printing position can be made shorter when the head travels from the intermediate standby position than when the head travels from the standby position.

FIG. 12A illustrates an example of the position of each discharge head 11 for when the first mode is selected as the printing mode. The discharge heads 11d to 11g, which discharge basic color inks, are located at the printing position, and the discharge heads 11a to 11c, which discharge spot color inks, are located at the intermediate standby position. The form of FIG. 5A and the form of FIG. 12A may be selected.

FIG. 12B illustrates an example of the position of each discharge head 11 for when the third mode is selected as the printing mode. Only the discharge head 11g for discharging black ink is located at the printing position, and the other discharge heads 11a to 11f are located at the intermediate standby position.

In the first embodiment, the positions of the discharge heads 11 are changed in units of print jobs, but the positions of the discharge heads 11 may be changed in units of pages. In the case of the present embodiment, since the intermediate standby position is set, by having the discharge heads 11 that are scheduled to be used in a later page on standby at the intermediate standby position, the time for raising or lowering the discharge heads 11 can be reduced. Specifically, print data is referenced over a plurality of pages, and for each discharge head 11, the height of the discharge head 11 is individually switched during execution of the print job when it is found that there is a certain period of non-use.

FIG. 12C illustrates an example of settings for the evaporation speed for each position. At the intermediate standby position (height H3), the discharge port surface 110 is closer to the printing medium 100 than at the standby position (height H2), and so, an airflow received by the discharge ports OP is stronger. Therefore, the evaporation speed at the intermediate standby position (height H3) is an intermediate value between the printing position (height H1) and the standby position (height H2).

In the present embodiment, when the processing of FIG. 9A is executed, it is sufficient that the evaporated quantity V is calculated in units of pages.

### Third Embodiment

In the present embodiment, a method of calculating an evaporated quantity taking into account an airflow that changes depending on the presence or absence of the printing medium 100 will be described. The number and the positions of holes H of the conveyance belt 17a covered by the printing medium 100 vary depending on the size of the printing medium 100. Therefore, there are holes H that are exposed to the discharge ports OP and holes H covered by the printing medium 100, and the discharge ports OP affected by the air suctioned into the holes H will vary.

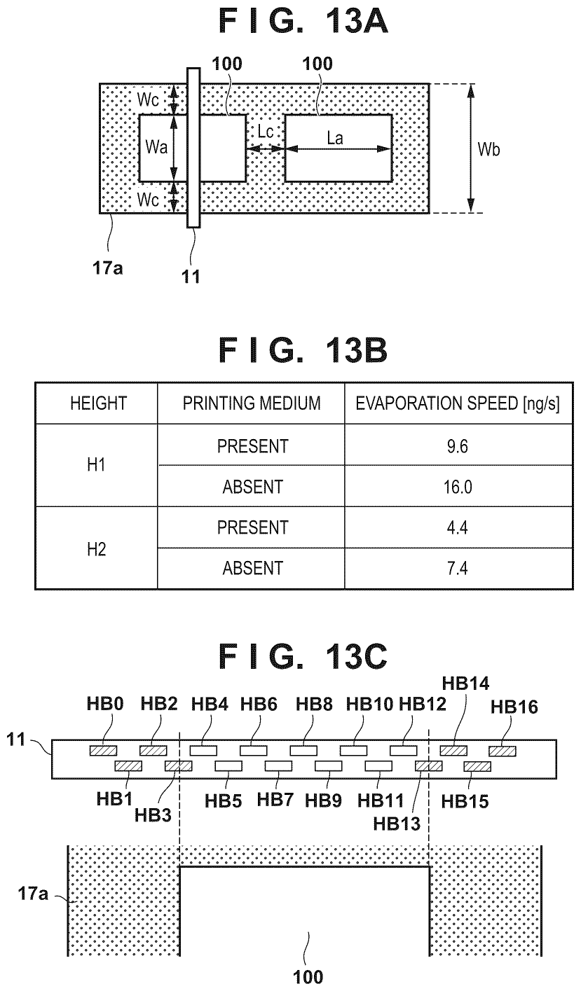

FIG. 13A is an explanatory view thereof. FIG. 13A is a view of the conveyance belt 17a seen from above, and for the sake of descriptive simplicity, only one of the discharge heads 11 is illustrated. The printing medium 100 has a size, the width Wa, relative to the width Wb of the conveyance belt 17a. In the Y direction, a range of a width Wc (=(Wa+Wb)/2) of the conveyance belt 17a is not covered by the printing medium 100.

During the printing operation, the discharge ports OP of the discharge head 11 is at a position facing the conveyance belt 17a and the printing medium 100. As a result of examination by inventors, it has been found that there is a difference in airflow received by the discharge ports OP at a place where the printing medium 100 covers the conveyance belt 17a (portion inside the width Wa) and a place where the printing medium 100 does not cover the conveyance belt 17a (portion outside the width Wa (portion inside the width Wc)). That is, in a portion inside a width covered by the printing medium 100, there only is an airflow generated by the conveyance of the printing medium 100. However, in a portion outside the width not covered by the printing medium 100, there is an airflow generated by the suction of the suction apparatus 17c in addition to the airflow that is generated by the movement of the conveyance belt 17a. Therefore, a stronger airflow acts on the discharge ports OP in the latter portion than in the former portion.

The change of the airflow with the presence or absence of the printing medium 100 is not only for the Y direction but is similar also for the X direction. An airflow is relatively stronger in a page interval Lc between a precedingly-conveyed printing medium 100 and a subsequent printing medium 100 than in a section La corresponding to the total length of the printing medium 100. That is, the discharge ports OP at the position in the width Wc is normally not covered by the printing medium 100 during the printing operation. Meanwhile, the discharge ports OP at the position in the width Wa alternate between the section La in which the printing medium 100 is present and the page interval Lc.

The evaporation speed of ink from the discharge ports OP change depending on these differences and changes in airflow. Therefore, by separately calculating and adding for each discharge port an evaporated quantity of a period in which the discharge port is covered by the printing medium 100 and an evaporated quantity of a period in which the discharge port is not covered by the printing medium 100, it is possible to calculate a more accurate total evaporated quantity.

FIG. 13B is a diagram illustrating an example of settings for the evaporation speed in the present embodiment. The settings for the evaporation speed vary depending on the presence or absence of the printing medium 100 in addition to the height H1 or H2 of the discharge head 11, and the evaporation speed is lower when the printing medium 100 is present than when the printing medium 100 is absent. The information of the size of the printing medium 100 is an example of information identifying the width of the printing medium 100 and an example of information related to the speed of airflow at the discharge port surface 110 of the discharge head 11. An example of processing for calculating an evaporated quantity by the density adjustment unit 29 will be described.

When a print instruction is received, information of the size (width Wa and total length La) of the printing medium 100 is obtained. The total length La of the printing medium 100 to be conveyed is accumulated for the number of sheets conveyed during the printing operation. A cumulative value is set to be La (sum). A time Ta obtained by dividing the cumulative value La (sum) by the conveyance speed of the printing medium 100 is calculated.

An evaporated quantity Va that has evaporated from the discharge ports OP positioned in the width Wa among the discharge ports OP of the discharge head 11 positioned at the printing position (height H1) is Va=[evaporation speed 9.6×Ta+evaporation speed 16.0×(print time T-Ta)]×number of discharge ports. An evaporated quantity Vc from the discharge ports OP positioned at the width Wc can be calculated using this equation with Ta=0. An evaporated quantity of the entire discharge head 11 is calculated by evaporated quantity=Va+Vc. The evaporated quantity of the discharge head 11 positioned at the standby position (height H2) can also be calculated similarly by changing the value of the evaporation speed.

In this example, an evaporated quantity is calculated by separating the discharge ports OP into the number of discharge ports facing an area of the width Wa and the number of discharge ports facing an area of the width Wc according to the presence or absence of the printing medium 100. However, area division is not limited to units of discharge ports and may be in units of heater boards. When area division is performed in units of heater boards, in order to prevent the evaporation speed from being calculated to be excessively low, the evaporated quantity may be calculated, assuming that, in a heater board that includes one or more discharge ports not covered by a printing medium, all the discharge ports of the heater board are not covered by a printing medium. FIG. 13C illustrates an example in which area division is performed in units of heater boards. Heater boards that include one or more discharge ports not covered by the printing medium 100 are HB0 to HB3 and HB13 to HB16. The evaporated quantities of these heater boards are calculated with Ta=0.

### Fourth Embodiment

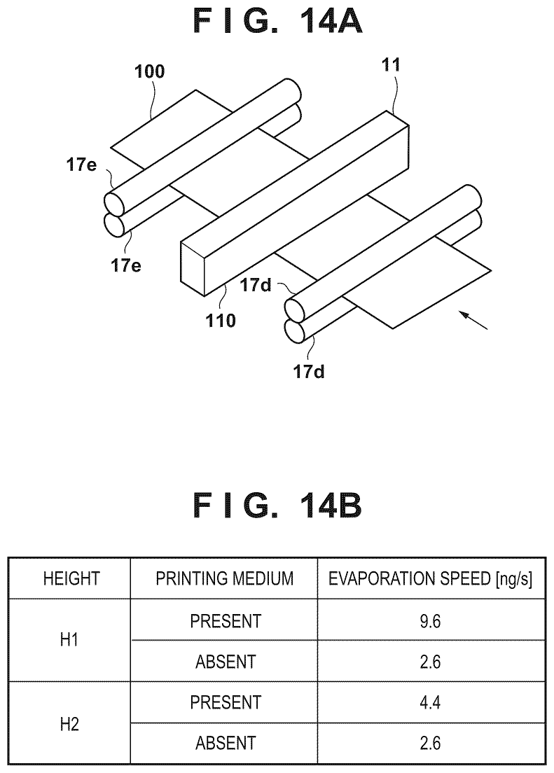

In the above embodiment, a conveyance belt-type conveyance mechanism has been exemplified as the conveyance unit 17, but it may be a roller-type conveyance mechanism. FIG. 14A is a schematic diagram illustrating an example thereof. For the sake of descriptive simplicity, only one discharge head 11 is illustrated. A pair of rollers 17d are arranged on an upstream side of the discharge head 11 in the conveyance direction of the printing medium 100, and a pair of rollers 17e are arranged on a downstream side. The pair of rollers 17d convey the printing medium 100 by their rotation while pinching the printing medium 100. Similarly, the pair of rollers 17e convey the printing medium 100 by their rotation while pinching the printing medium 100.

In such a roller-type conveyance mechanism, the suction apparatus 17c is not provided. Therefore, at the discharge port surface 110 of the discharge head 11, the airflow is relatively weaker in a portion in which the printing medium 100 is absent (a portion not facing the printing medium 100) than in a portion in which the printing medium 100 is present (a portion facing the printing medium 100). Further, the ranges of such portions vary depending on the size (width) of the printing medium 100.

FIG. 14B is a diagram illustrating an example of settings for the evaporation speed in the present embodiment. The settings for the evaporation speed vary depending on the presence or absence of the printing medium 100 in addition to the height H1 or H2 of the discharge head 11. The relationship is reversed from the example FIG. 13B, and the evaporation speed is faster in the discharge ports OP inside the width of the printing medium 100 than in the discharge ports OP outside the width. In addition, for the discharge ports OP that are outside the width of the printing medium 100, there is no difference in the evaporation speed depending on the height H1 or H2. These are the features of the evaporation speed in the roller type. The processing for calculating the evaporated quantity by the density adjustment unit 29 is similar to that of the third embodiment, and the evaporated quantity can be calculated similarly by changing the value of the evaporation speed.

### Fifth Embodiment

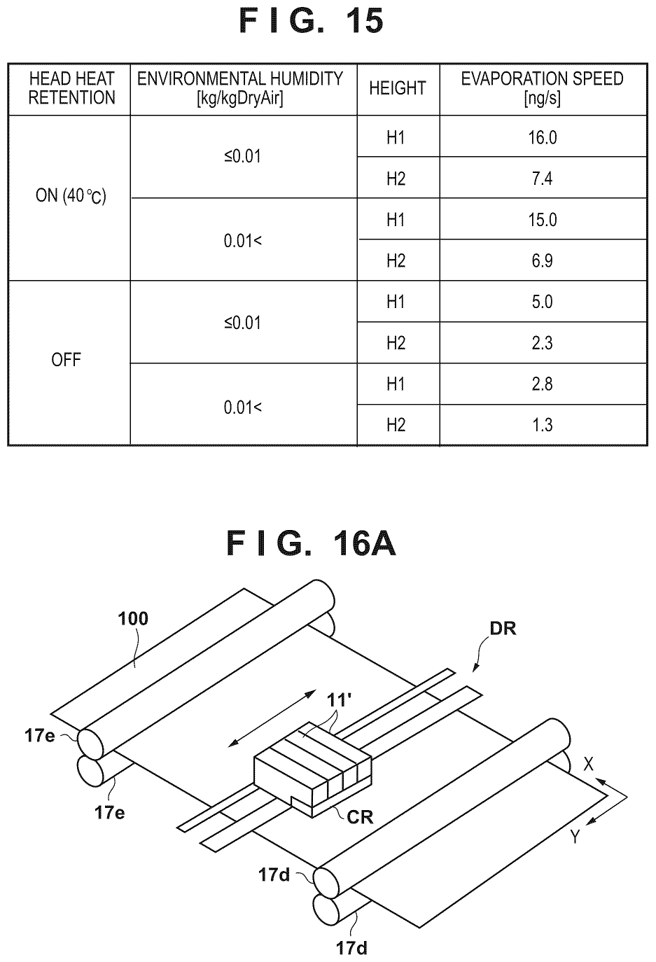

When setting the evaporation speed, elements other than the airflow at the discharge port surface 110 may be taking into account. FIG. 15 is a diagram illustrating an example of settings for the evaporation speed in the present embodiment, and the evaporation speeds for conditions for head heat retention and environmental humidity are defined in addition to the positions (heights H1 and H2) of the discharge head 11.

Head heat retention is an operation of retaining the heat of the discharge head 11 by driving the sub heaters SH of the discharge head 11 and is switched between two stages, ON and OFF, according to the printing mode. When head heat retention is ON, results of detection of temperature sensors SR are monitored, and the temperature of the discharge head 11 is maintained at, for example, 40° C. (Celsius). When head heat retention is OFF, the temperature of the discharge head 11 is maintained at, for example, 20° C., depending on the temperature of the supplied ink. The higher the temperature, the faster the evaporation speed, and so, even in the example of settings of FIG. 15, the evaporation speed is relatively fast in the case of ON and relatively slow in the case of OFF.

Head heat retention can be switched ON and OFF depending on the use or non-use of the discharge head 11 according to the printing mode as described in the first embodiment. For example, when the first mode is selected, head heat retention is turned ON for the discharge heads 11d to 11g used for printing, and head heat retention is turned OFF for the discharge heads 11a to 11c not used for printing. The information of ON or OFF of head heat retention or the selection information of the printing mode is an example of the temperature information of the discharge head 11.

As another example of switching head heat retention ON and OFF, the presence or absence of the printing medium 100 described in the third embodiment or the fourth embodiment may be used as a reference. For example, head heat retention may be set to ON for the discharge ports OP at a position facing the printing medium 100, and head heat retention may be set to OFF for the discharge ports OP at a position not facing the printing medium 100. The evaporated quantity may be calculated by calculating an evaporated quantity for the discharge ports OP for which head heat retention is ON and an evaporated quantity for the discharge ports OP for which head heat retention is OFF and then adding the evaporated quantities of all the discharge ports.

The environmental humidity refers to the humidity of a surrounding atmosphere in which the printing apparatus 1 is installed. The environmental humidity can be detected by a humidity sensor (not illustrated) provided in the printing apparatus 1. The lower the humidity, the faster the evaporation speed. A result of detection of the humidity sensor is obtained as humidity information, and the evaporation speed can be set according to the example of FIG. 15. In the illustrated example, the evaporation speed is set to vary with 0.01 (kg (kilogram) surrounding air/kg dry air) as the threshold. However, the threshold may be of another value.

By thus setting the evaporation speed according to not only the airflow at the discharge port surface 110 but also a combination of conditions for head heat retention and humidity, it is possible to more accurately estimate the concentration state of ink.

### Sixth Embodiment

In the first to fifth embodiments, a full-line head is exemplified as the discharge head 11, but the present disclosure is also applicable to a serial printing apparatus. FIG. 16A is a schematic diagram illustrating an example thereof. A plurality of discharge heads 11′ are mounted on a carriage CR, and the carriage CR is reciprocated by a scanning mechanism DR in a direction (Y direction) traversing the printing medium 100.

The scanning mechanism DR is, for example, a belt transmission mechanism and includes a pair of pulleys spaced apart in the Y direction, an endless belt wound around the pair of pulleys, and a motor for rotating the pulleys. The carriage CR is fixed to the endless belt, and the carriage CR is moved by the endless belt traveling by being driven by the motor. The scanning mechanism DR is an example of a moving mechanism that moves the discharge heads 11′ and the printing medium 100 in a relative manner.

In the example of FIG. 16A, the printing medium 100 is conveyed by a roller-type conveyance mechanism, similarly to the fourth embodiment. However, it may be a conveyance belt-type conveyance mechanism as in the first embodiment. An image is printed by alternately repeating the conveyance operation (intermittent conveyance operation) in which each pair of rollers 17d and 17e convey the printing medium 100 by a predetermined amount in the X direction and a print scan that is performed during a conveyance stop. The print scan is an operation in which ink is discharged from the discharge heads 11′ while moving the carriage CR on which the discharge heads 11′ are mounted.

In such a serial configuration, a scan speed of the discharge heads 11′ is a factor that changes the airflow at the discharge port surfaces, and the faster the scan speed, the faster the evaporation speed of ink at the discharge ports OP. That is, the scan speed affects the evaporation speed. FIG. 16B is a diagram illustrating an example of settings for the evaporation speed in the present embodiment. Here, the evaporation speed is set according to a combination of the height and the scan speed.

The heights H11 to H13 indicate positions of the discharge heads 11′ in the Z direction relative to the printing medium 100 and all are printing positions corresponding to the height H1 of the first embodiment. In the present embodiment, there are three types of printing positions, and all of the discharge heads 11′ are raised and lowered collectively without individually raising and lowering the discharge heads 11′. The elevating mechanism may be provided, for example, on the scanning mechanism DR. The heights H11 to H13, for example, can be set to 1 mm, 1.5 mm, and 2.5 mm, in order. The higher the height, the slower the evaporation speed of ink from the discharge ports OP.

The heights H11 to H13 and the scan speed are switched according to the selection of the printing mode. In the present embodiment, combinations of the type (three types—photo paper, plain paper, and envelope) of the printing medium 100 and the quality (fast and standard) of printing are assumed as the printing modes. The printing mode can be selected by the user.

The heights H11 to H13 depend on the type of the printing medium 100, and the scan speed depends on the quality of printing. The selection information of the type of the printing medium 100 or the quality of printing is an example of information related to the speed of airflow at the discharge port surface 110, and the selection information of printing quality is an example of information identifying the scan speed.

The evaporated quantity is calculated by accumulating values obtained by multiplying the evaporation speed of FIG. 16B by the print time. The print time per scan is calculated by the width in the Y direction=the scan speed, and the print time per page is a value obtained by accumulating that for the number of scans.

In the example of FIG. 16B, the evaporation speed is set according to the heights H11 to H13, but the height of the discharge head 11 may be fixed, and in this case, the evaporation speed is set based on the scan speed.

### Seventh Embodiment

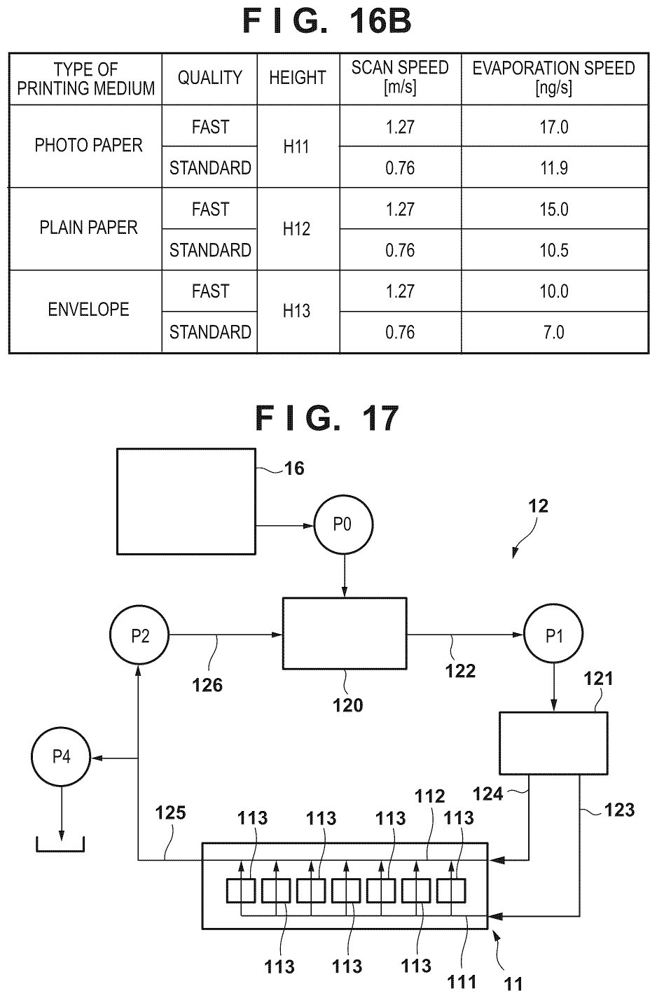

In the first to sixth embodiments, the discharge of ink from the discharge heads 11 and 11′ is exemplified as an adjustment operation for adjusting the density of the solid component in ink circulated by the circulation unit 12, but ink may be discharged from another portion of the circulation path of ink. FIG. 17 illustrates an example thereof. In the example of the figure, an example in which a pump P4 for discharging ink to a waste liquid tank from the tube 125 is provided between the discharge head 11 and the pump P2 is illustrated. The concentrated ink can be discharged by the pump P4 at a position downstream of the discharge head 11 in the flow direction of the circulating flow of ink.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-195294, filed Nov. 16, 2023, which is hereby incorporated by reference herein in its entirety.

What is claimed is:

1. A printing apparatus comprising:
a moving unit configured to relatively move a printing medium and a discharging unit configured to discharge a liquid onto the printing medium; and
a control unit configured to obtain information related to a speed of airflow at a discharge port surface of the discharging unit and, based on the obtained information, control an adjustment operation for adjusting a density of a solid component of the liquid,
wherein a printing mode is selectable from a plurality of types of printing modes, and
the information includes information identifying a type of a selected printing mode.

2. The printing apparatus according to claim 1, wherein
a height from a surface of the printing medium to the discharge port surface of the discharging unit is changeable, and
the information includes information identifying the height.

3. The printing apparatus according to claim 1, wherein
the moving unit is a conveyance unit configured to convey the printing medium, and
the information includes information identifying a width of the printing medium.

4. The printing apparatus according to claim 1, wherein
the moving unit is a scanning unit configured to cause the discharging unit to reciprocate in a direction that traverses the printing medium, and
the information includes information identifying a scan speed of the discharging unit.

5. The printing apparatus according to claim 1, further comprising a circulation unit configured to circulate the liquid between a liquid storage unit configured to store the liquid and the discharging unit.

6. The printing apparatus according to claim 1, wherein
the adjustment operation includes an operation of discharging the liquid from the discharging unit.

7. The printing apparatus according to claim 1, wherein
the adjustment operation includes an operation of suctioning the liquid from the discharging unit.

8. The printing apparatus according to claim 1, wherein
the discharging unit is a full-line discharge head.

9. The printing apparatus according to claim 2, wherein
the control unit is configured to set an evaporation speed based on the obtained information, estimate an evaporated quantity of the liquid from the discharge port surface based on the set evaporation speed, and control the adjustment operation based on the estimated evaporated quantity, and
when the height is high, the control unit is configured to set the evaporation speed to be lower than when the height is low.

10. The printing apparatus according to claim 9, wherein
the control unit is configured to estimate the evaporated quantity in a case where a print job has been executed, estimate the density based on the estimated evaporated quantity and a content of a printing operation in the print job, and execute the adjustment operation in a case where the estimated density exceeds a threshold.

11. The printing apparatus according to claim 2, wherein
the control unit is configured to obtain humidity information, set an evaporation speed based on the obtained information and humidity information, estimate an evaporated quantity of the liquid from the discharge port surface based on the set evaporation speed, and control the adjustment operation based on the estimated evaporated quantity,
in a case where the height is high, the control unit is configured to set the evaporation speed to be lower than in a case where the height is low, and
in a case where humidity indicated by the humidity information is high, the control unit is configured to set the evaporation speed to be lower than in a case where the humidity is low.

12. The printing apparatus according to claim 2, wherein
the control unit is configured to obtain temperature information of the discharging unit, set an evaporation speed based on the obtained information and temperature information, estimate an evaporated quantity of the liquid from the discharge port surface based on the set evaporation speed, and control the adjustment operation based on the estimated evaporated quantity, and
in a case where the height is high, the control unit is configured to set the evaporation speed to be lower than in a case where the height is low, and
in a case where a temperature indicated by the temperature information is high, the control unit is configured to set the evaporation speed to be lower than in a case where the temperature is low.

13. The printing apparatus according to claim 2, further comprising a plurality of discharging units,
wherein the height is changeable for each discharging unit,
the height is set to a first height upon printing and to a second height upon non-printing, and
the second height is higher than the first height.

14. The printing apparatus according to claim 13, wherein
the control unit is configured to control change of the height and control, for each discharging unit, change of the height during execution of a print job based on the print job.

15. The printing apparatus according to claim 2, further comprising an elevating unit configured to elevate the discharging unit.

16. The printing apparatus according to claim 3, wherein
a plurality of discharge ports is provided at the discharge port surface,
the conveyance unit is configured to convey the printing medium while suctioning the printing medium to a conveyance medium by suctioning of air, and
the control unit is configured to set for each discharge port an evaporation speed based on the obtained information, estimate an evaporated quantity of the liquid from the discharge port surface based on the set evaporation speed, and control the adjustment operation based on the estimated evaporated quantity, and
the control unit is configured to set an evaporation speed of a discharge port positioned inside a width of the printing medium to be lower than an evaporation speed of a discharge port positioned outside the width of the printing medium.

17. The printing apparatus according to claim 3, wherein
a plurality of discharge ports is provided at the discharge port surface,
the conveyance unit is configured to convey the printing medium by rotation of a roller, and
the control unit is configured to set for each discharge port an evaporation speed based on the obtained information, estimate an evaporated quantity of the liquid from the discharge port surface based on the set evaporation speed, and control the adjustment operation based on the estimated evaporated quantity, and
the control unit is configured to set an evaporation speed of a discharge port positioned inside a width of the printing medium to be lower than an evaporation speed of a discharge port positioned outside the width of the printing medium.

18. A method of controlling a printing apparatus including a moving unit configured to relatively move a printing medium and a discharging unit configured to discharge a liquid onto the printing medium, the method comprising:
obtaining information related to a speed of airflow at a discharge port surface of the discharging unit; and
controlling an adjustment operation for adjusting a density of a solid component of the liquid based on the obtained information,
wherein a printing mode is selectable from a plurality of types of printing modes, and
the information includes information identifying a type of a selected printing mode.
